(19) United States
(12) Patent Application Publication
(10) Pub. No.: US 2005/0122024 A1
(43) Pub. Date: Jun. 9, 2005

(54) Sealing device and sealing method

(76) Inventors: Klaus Hrastnik, Stuttgart (DE); Simon Schmittinger, Renningen (DE); Dieter Holz, Affalterbach (DE)

Correspondence Address: KENYON & KENYON, ONE BROADWAY, NEW YORK, NY, 10004, US

(21) Appl. No.: 10/498,040

(22) PCT Filed: Sep. 25, 2002
(86) PCT No.: PCT/DE02/03625

(30) Foreign Application Priority Data
Dec. 7, 2001 (DE) 101 60 301.0

(51) Int. Cl. H01T 13/22; B60L 1/02; G01N 27/26

(52) U.S. Cl. 313/144; 219/205; 204/424

(57) ABSTRACT

A sealing apparatus and a method for sealing, which make possible reduced installation space and assembly at room temperature, are proposed. The sealing apparatus encompasses a ceramic base element and a metallic housing. The ceramic base element comprises on an outer wall at least one circumferential flute in the region of which the housing is pressed in positively fitting fashion onto the ceramic base element.

### FIELD OF THE INVENTION

The present invention is based on a sealing apparatus, and from a method for sealing.

### BACKGROUND INFORMATION

In order to ensure the functionality of, for example, a spark plug, engine gases must not escape between a spark plug housing and a ceramic insulator of the spark plug. The ceramic insulator must be installed sealedly into the spark plug housing in such a way that gas-tightness is guaranteed at up to 20 bar, at a maximum temperature of 220° C.

Known for this purpose, for example, is hot assembly, in which the spark plug housing, after introduction of the ceramic insulator, is heated to approximately 950° C. in the region of a shrinkage zone. During this, the spark plug housing is pressed onto the ceramic insulator by applied forces. Upon cooling of the shrinkage zone, tensile stresses are produced in the spark plug housing with respect to the ceramic insulator. The applied forces are then removed. The ceramic insulator is thereby sealed in gas-tight fashion with respect to the spark plug housing.

A further method for gas-tight sealing of the ceramic insulator with respect to the spark plug housing is achieved by way of a cold assembly method with powder sealing. Here the ceramic insulator, together with a fine ceramic powder, is pushed under load into the spark plug housing. The upper rim of the spark plug housing, through which the ceramic insulator was introduced into the spark plug housing, is then clinched over by axial forces in a crimping process, so that the spark plug housing abuts, at its upper rim as well, against the ceramic insulator and holds the latter in the spark plug housing in gas-tight and sealing fashion.

### SUMMARY OF THE INVENTION

The sealing apparatus and method for sealing according to the present invention having the features of the independent claims have, in contrast, the advantage that the ceramic base element comprises on an outer wall at least one circumferential flute in the region of which the housing is pressed in positively fitting fashion onto the ceramic base element. This makes possible assembly of the sealing apparatus at room temperature. As a result, all common corrosion protection coatings, for example zinc, transparent chromating, or corrosion protection lacquer, can be applied onto the metallic housing prior to assembly of the sealing apparatus. Furthermore, it is not necessary for the ceramic base element to have a shoulder in the region of the upper rim of the housing through which the ceramic base element is introduced into the housing, as is the case, for example, with spark plugs in order to receive a crimping of the upper rim of the housing. To the contrary, the gas-tight seal is ensured solely by the pressing of the housing onto the ceramic base element in the region of the at least one flute. Because the aforesaid shoulder is omitted, the ceramic base element can be implemented with a smaller cross-sectional area and thus with a smaller diameter. This is advantageous in particular for use of the sealing apparatus in a spark plug, a sheathed-element glow plug, or a lambda sensor, since space in the cylinder head or in the exhaust system is thus saved and is therefore available for other components, for example injection valves or cooling channels.

It is advantageous if the ceramic base element is at least partially solder-joined to the housing. The gas-tightness of the sealing apparatus can be even further enhanced in this fashion.

A particularly simple method for sealing the ceramic base element in the metallic housing results when the ceramic base element, in the context of a mechanical reshaping method, in a first step is introduced into the housing substantially coaxially with the housing, and when in the second step a reduction or drawing ring is placed on an outer boundary of the housing and is pushed in the radial direction into at least one flute, in order to press the housing sealingly onto the ceramic base element in the region of the at least one flute. This process requires little outlay in terms of assembly and tools.

It is furthermore advantageous if the reduction or drawing ring is also pushed tangentially with respect to the at least one flute against the outer edge of the housing, while the ceramic base element is held in the housing against the tangential force. In this fashion the housing is pressed, in the region of the at least one flute, against a delimiting wall of the flute both radially and also tangentially with respect to the at least one flute, so that a greater gas-tightness of the resulting positive fit between housing and ceramic base element can be achieved.

A further increase in gas-tightness can also be achieved by heating the housing, before the second step of pressing the housing in positively fitting fashion onto the ceramic base element in the region of the at least one flute, so that the housing elongates; and by cooling the housing after the second step so that it contracts and tensile stresses are produced in the housing with respect to the ceramic base element in the region of the at least one flute. This feature once again enhances the hot tightness of the seal that is formed between the ceramic base element and the metallic housing. “Hot tightness” is understood here as the tightness, in particular the gas-tightness, of the sealing apparatus upon heating.

A further advantage lies in the fact that the housing is heated to approximately 300° C. As a result, all common corrosion protection coatings, for example zinc, transparent chromating, or corrosion protection lacquer, can be applied before assembly of the sealing apparatus and before sealing of the ceramic base element in the metallic housing, without causing those corrosion protection coatings to reach their melting point as a result of the heating.

A further advantage lies in the fact that the ceramic base element is cooled during heating of the housing. This increases the temperature difference between the housing and the ceramic base element, thereby increasing, the tensile stresses produced in the housing, after cooling of the housing, with respect to the ceramic base element in the region of the at least one flute.

### BRIEF DESCRIPTION OF THE DRAWINGS

FIG. 1 shows the method step essential for the method for sealing according to the present invention.

FIG. 2 shows the sealing apparatus according to the present invention constituted by such a method.

### DETAILED DESCRIPTION

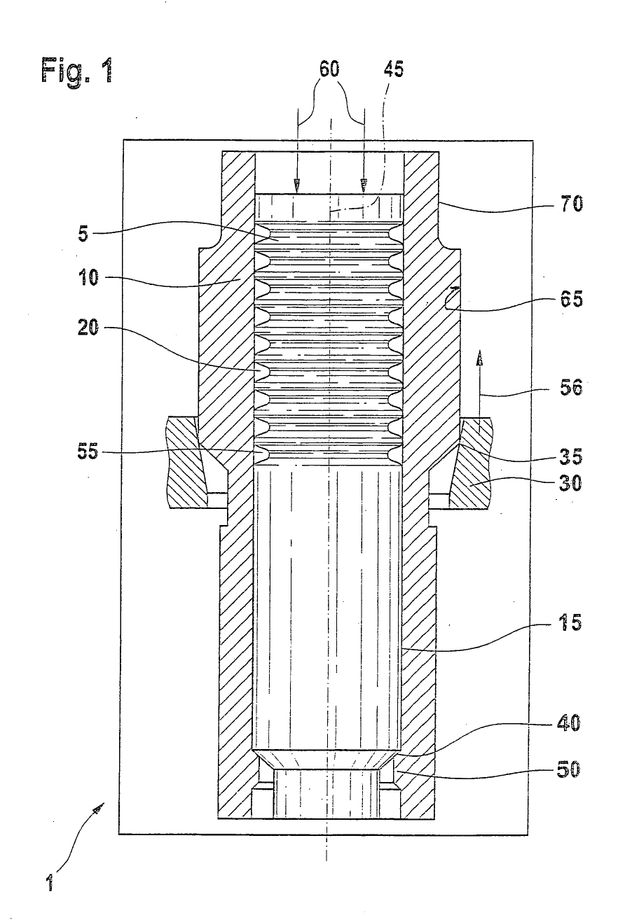

In FIG. 1, 1 designates a sealing apparatus that can be used, for example, for a spark plug, a sheathed-element glow plug, or a lambda sensor. In the case of the spark plug or sheathed-element glow plug, the sealing apparatus is used in an engine compartment, for example in a cylinder head; whereas in the case of a lambda sensor it is used in an exhaust duct. Sealing apparatus 1 encompasses a ceramic base element 5 that has, on an outer wall 15, at least one circumferential flute 20. In FIG. 1, sealing apparatus 1 that is to be constituted is shown in a longitudinal section, flutes 20 being implemented in the form of constrictions around the circumference of outer wall 15 that reduce the cross-sectional area and the diameter of the cross section of ceramic base element 5. In a first method step upon assembly of sealing apparatus 1, ceramic base element 5 is introduced or inserted into a metallic housing 10 along a longitudinal axis 45 of housing 10. Ceramic base element 5 has a sealing seat 40 at which, upon introduction into housing 10, it makes contact against a sealing ring 50 protruding in the interior of housing 10.

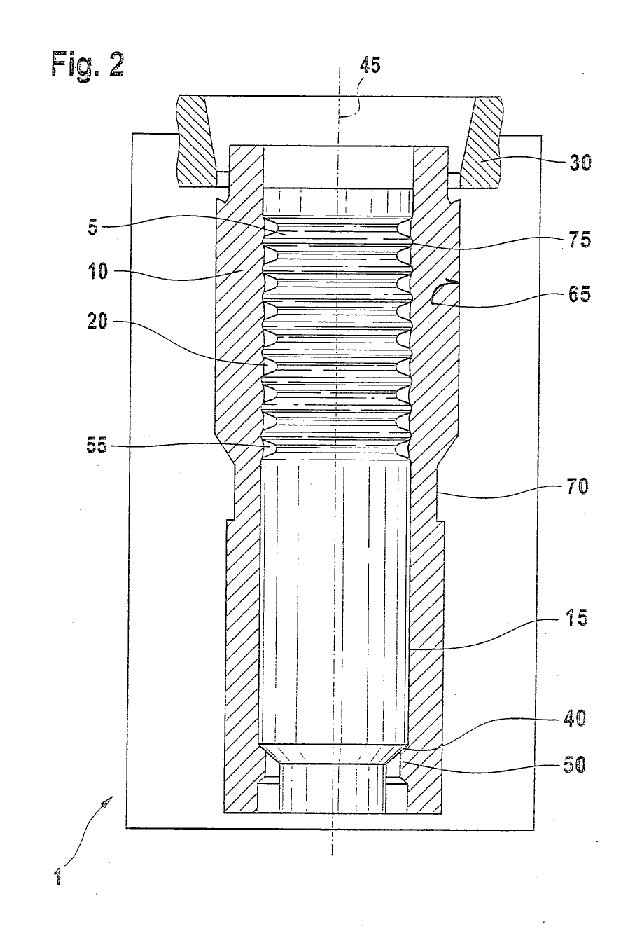

Ceramic base element 5 lies in housing 10 substantially coaxially with housing 10 with respect to longitudinal axis 45, as shown in FIG. 1. In the region of a bottommost flute 55, facing toward sealing seat 40, of ceramic base element 5, housing 10 has a circumferential outer edge 35. In a second method step, a reduction or drawing ring 30 is placed on this outer edge 35. The inside diameter of reduction or drawing ring 30 proceeds from a value that is less than the diameter of outer edge 35 to a value that is greater than the diameter of outer edge 35. For this exemplary embodiment, it is to be assumed by way of example that ceramic base element 5 and housing 10 are disposed in substantially rotationally symmetrical fashion, and have a cross section of substantially circular or annular shape. When reduction or drawing ring 30 is then placed, with its inside diameter varying as described, on outer edge 35, and is pushed by an application force against outer edge 35 oppositely to the insertion direction of ceramic base element 5, in the arrow direction labeled with reference character 55, radial and tangential forces thus act on ceramic base element 5 in the region of flutes 20. The radial forces are directed toward longitudinal axis 45 and thus toward flutes 20, and are thus perpendicular to arrow direction 55. The tangential forces extend tangentially with respect to flutes 20 and thus in arrow direction 55. In this operation, ceramic base element 5 is pushed into housing 10 in the insertion direction (which is identified in FIG. 1 by reference character 60 and thus extends oppositely to arrow direction 55), and is held in housing 10 in the region of sealing ring 50 and sealing seat 40. Outer edge 35 is part of an elevation 65 on an outer wall 70 of housing 10. Elevation 65 of housing 10 extends substantially in the region in which ceramic base element 5, inserted into housing 10, has flutes 20. Reduction or drawing ring 30 is displaced by corresponding pressure over elevation 65 in arrow direction 55 oppositely to insertion direction 60, beginning at outer edge 35, so that housing 10 is pressed in positively fitting fashion onto ceramic base element 5 in the region of elevation 65 and thus of flutes 20. As a result of the variable inside diameter (as described) of reduction or drawing ring 30, which diameter assumes smaller values even than the diameter of outer edge 35 and thus of elevation 65 as depicted in FIG. 1, elevation 65 is reduced to this smallest inside diameter of reduction or drawing ring 30. This is depicted in FIG. 2, in which the positively fitting join thus formed between housing 10 and ceramic base element 5 after pressing is illustrated by way of reference character 75. In this context, housing 10 conforms to a certain extent, in the region of flutes 20, to the delimiting walls of flutes 20. With suitable pressure from reduction or drawing ring 30 upon displacement over elevation 65 in arrow direction 55, the join formed between housing 10 and ceramic base element 5 in the region of flutes 20 is also gas-tight, for example to 20 bar. The method described for pressing housing 10 onto ceramic base element 5 in the region of flutes 20 is a mechanical reshaping method.

As an alternative to the mechanical reshaping method just described, provision can also be made to compress housing 10 at elevation 65 in the radial direction with respect to longitudinal axis 45 (and thus to flutes 20), for example by using round pliers, in order to press housing 10 onto ceramic base element 5 in the region of flutes 20. A tangential force, as depicted by arrow direction 55 in FIG. 1 for the first exemplified embodiment, is then not applied in this alternative embodiment. With appropriate radial pressure, however, a correspondingly gas-tight join can likewise be achieved between housing 10 and ceramic base element 5 in the region of flutes 20, housing 10 once again, as depicted in FIG. 2, conforming to a portion of the delimiting walls of flutes 20.

The radial and/or tangential forces described can also, alternatively or additionally, be achieved by way of a magnetic reshaping method, in which a correspondingly strong magnetic field is created in a short period in the region of elevation 65 so that housing 10 is pressed onto ceramic base element 5 in the manner described.

Provision can additionally be made for housing 10 to be heated, especially in the region of elevation 65, before the second method step. As a result, housing 10 is elongated in the direction of longitudinal axis 45 in the region of elevation 65. The heating of housing 10 can be accomplished before or after the introduction of ceramic base element 5 into housing 10. When housing 10 is then cooled again after the second method step, it thus contracts in the region of elevation 65 so that tensile stresses are produced in housing 10, with respect to ceramic base element 5, in the region of flutes 20. These tensile stresses enhance the gas-tightness achieved, by way of the magnetic and/or mechanical reshaping method described, in the join between housing 10 and ceramic base element 5 as shown in FIG. 2. This effect can also be intensified if ceramic base element 5 is cooled or kept cool during the heating of housing 10. The temperature difference between ceramic base element 5 and housing 10 is thus increased, so that the tensile stresses produced after cooling of housing 10 are further increased. The tensile stresses brought about as a consequence of the heating of housing 10 also result in enhanced hot tightness of the sealing apparatus, i.e. an enhanced tightness when the sealing apparatus is operated at high temperatures, as is the case e.g. with spark plugs, sheathed-element glow plugs, or lambda sensors.

Advantageously, in order to produce the desired tensile stresses, housing 10 is heated to a temperature that is below the melting temperature of common corrosion protection coatings, for example zinc, transparent chromating, or corrosion protection lacquer. The advantageous result is that metallic housing 10 can be equipped, before the assembly of sealing apparatus 1, with such a corrosion protection coating, which then does not melt upon heating of housing 10 to produce the desired tensile stresses and is not thereby destroyed. Heating of the metallic housing 10 to approximately 300° C. satisfies the requirement that the desired tensile stresses be produced; this temperature also lies below the melting temperature of all common corrosion protection coatings.

The heating operation just described will be referred to hereinafter as “semi-hot” assembly.

Alternatively or in addition to semi-hot assembly, the gas-tightness of sealing apparatus 1 constituted by the above-described magnetic or mechanical reshaping operation can also be enhanced by the fact that in a third method step, ceramic base element 5 is at least partially soldered to housing 10. This requires the use of a solder that bonds both to the metallic housing 10 and to ceramic base element 5. This can be achieved, for example, with a silver solder. Gas-tightness is enhanced in particular, in this context, by the fact that ceramic base element 5 is soldered to housing 10 in the region of flutes 20 in which a seal between ceramic base element 5 and housing 10 has already been achieved, in the second method step, by way of the above-described magnetic and/or mechanical reshaping method and, optionally, by way of the above-described semi-hot assembly.

The number of flutes mentioned in ceramic base element 5 can be selected to be equal to 1 or any number greater than 1.

Ceramic base element 5 can be embodied as an insulator of a spark plug, and in that case is also referred to as a plug insulator. Metallic housing 10 is then, in this case, a plug housing of the spark plug.

Alternatively, however, ceramic base element 5 can also be embodied as the heating element of a sheathed-element glow plug, the metallic housing 10 then being a plug housing of the sheathed-element glow plug.

Alternatively, however, ceramic base element 5 can also be embodied as the base element of a lambda sensor, the metallic housing 10 then being a housing of the lambda sensor.

1-16. (canceled)

17. A sealing apparatus, comprising:
a ceramic base element; and
a metallic housing, wherein:
the ceramic base element includes on an outer wall at least one circumferential flute in a region of which the metallic housing is pressed in positively fitting fashion onto the ceramic base element.

18. The sealing apparatus as recited in claim 17, wherein:
the sealing apparatus is for one of an engine compartment and an exhaust duct.

19. The sealing apparatus as recited in claim 17, wherein:
the ceramic base element is at least partially solder-joined to the metallic housing.

20. The sealing apparatus as recited in claim 19, wherein:
the ceramic base element is solder-joined to the metallic housing in a region of the at least one circumferential flute.

21. The sealing apparatus as recited in claim 17, wherein:
the ceramic base element includes an insulator of a spark plug, and the metallic housing includes a plug housing of the spark plug.

22. The sealing apparatus as recited in claim 17, wherein:
the ceramic base element includes a heating element of a sheathed-element glow plug, and the metallic housing includes a plug housing of the sheathed-element glow plug.

23. The sealing apparatus as recited in claim 17, wherein:
the ceramic base element includes a base element of a lambda sensor, and
the metallic housing includes a housing of the lambda sensor.

24. A method for sealing a ceramic base element in a metallic housing, comprising:
inserting the ceramic base element into the metallic housing; and
pressing, in a positively fitting fashion, the metallic housing onto the ceramic base element in a region of at least one circumferential flute disposed on an outer wall of the ceramic base element.

25. The method as recited in claim 24, wherein:
the pressing of the metallic housing includes pressing on the metallic housing by way of a magnetic reshaping operation.

26. The method as recited in claim 24, wherein:
the pressing of the metallic housing includes pressing on the metallic housing by way of a mechanical reshaping method.

27. The method as recited in claim 26, wherein:
the inserting of the ceramic base element includes introducing the ceramic base element into the metallic housing substantially coaxially with the metallic housing, and
the pressing of the metallic housing includes placing one of a reduction ring and a drawing ring on an outer edge of the metallic housing and pushing the one of the reduction ring and the drawing ring radially toward the at least circumferential one flute in order to press the metallic housing sealingly onto the ceramic base element in the region of the at least one circumferential flute.

28. The method as recited in claim 27, further comprising:
pushing the one of the reduction ring and the drawing ring tangentially with respect to the at least one circumferential flute against the outer edge of the metallic housing, while the ceramic base element is held in the metallic housing against the tangential force.

29. The method as recited in claim 24, further comprising:
before the pressing of the metallic housing, heating the metallic housing in order to elongate the metallic housing; and
after the pressing of the metallic housing, cooling the metallic housing in order to contract the metallic housing, thereby producing tensile stresses in the metallic housing with respect to the ceramic base element in the region of the at least one circumferential flute.

30. The method as recited in claim 29, wherein:
the metallic housing is heated to approximately 300° C.

31. The method as recited in claim 29, further comprising:
during the heating of the metallic housing, cooling the ceramic base element.

32. The method as recited in claim 24, further comprising:
at least partially solder-joining the ceramic base element to the metallic housing.

33. The sealing apparatus as recited in claim 32, wherein:
the ceramic base element is solder-joined to the metallic housing in the region of the at least one circumferential flute.
